(19) United States
(12) Patent Application Publication
(10) Pub. No.: US 2011/0208610 A1
(43) Pub. Date: Aug. 25, 2011

(54) METHOD AND SYSTEM FOR EXCHANGING BUSINESS DOCUMENTS

(76) Inventors: Brent Halverson, Vancouver (CA); Ian Braby, North Vancouver (CA); Miroslav Stojanovic, Burnaby (CA)

(21) Appl. No.: 13/037,050

(22) Filed: Feb. 28, 2011

Related U.S. Application Data
(63) Continuation of application No. 12/040,763, filed on Feb. 29, 2008, now abandoned.
Application No. 12/040,763 is a continuation of application No. PCT/CA2006/001457, filed on Sep. 5, 2006.
(60) Provisional application No. 60/713,353, filed on Sep. 2, 2005.

(51) Int. Cl. G06Q 30/00

(52) U.S. Cl. 705/26.8; 705/26.1; 705/27.1

(57) ABSTRACT

A method of exchanging a business document between a customer computer and a supplier computer connected to a network, is provided, in which a business document is printed for the supplier; order data from the purchase order is extracted through a printer driver; the order data is transmitted to the supplier computer; the business document is presented on the supplier computer in a form pre-selected by said supplier; the business document is amended by making a change; the amended business document is printed; the amended order data is extracted by the printer driver from said amended business document; the change is determined by comparing the order data from the business document to the amended order data from the amended business document; the amended business document is transmitted to the customer computer, and presented such that said data prior to the change appears as crossed out.

### CROSS-REFERENCE TO RELATED APPLICATIONS

This application is a continuation of PCT International Application No. PCT/CA2006/001457, filed Sep. 5, 2006, which claims priority to U.S. Provisional Application No. 60/713,353, filed Sep. 2, 2005, to which this application also claims priority, both of which are incorporated herein by reference in their entireties.

### BACKGROUND OF THE INVENTION

1. The Field of the Invention

The system and method according to the invention relates to software trading platforms, and more particularly to platforms that allow companies to exchange business documents, such as order management documents, across the Internet in a secure, bidirectional, and cost-effective manner.

2. The Relevant Technology

The current method for most companies to transact business is through a paper-based print and fax process. This paper-based process is labor intensive, error prone and inefficient. Many businesses would therefore prefer to transact business electronically with their trading partners (including both customers and suppliers) to not only lower costs (by reducing labor costs and errors) but also to gain a competitive advantage (such as speed to market and a closer relationship with trading partners). Electronic transactions also increase efficiency and scalability, for example by allowing participants to react to changing market demands without incurring prohibitive costs.

Existing electronic trading solutions are “expensive” in terms of cost, time to implement and the business process changes required, such that businesses are only able to create electronic trading connections with a small percentage of their trading partners.

Electronic Data Interchange (“EDI”) is an electronic trading solution that has been in use for over 30 years but due to the complexity and cost of implementing and maintaining EDI, it is generally used only by large companies transacting business amongst themselves, or by those that force the EDI standard on smaller suppliers and/or customers. This solution has limitations, including the following:

1. Additional, and often prohibitive, costs to design, implement and maintain are incurred by both trading partners making the solution inappropriate for some trading partners.

2. Once installed, EDI enables electronic transactions only with a single trading partner.

3. Small to mid-size Enterprise Resource Planning (ERP) or Material Requirements Planning (MRP) systems, usually deployed at Small and Medium-Sized Enterprise (SME) companies, often don't have well developed support for EDI, requiring customers to purchase additional expensive modules.

Another electronic trading solution known as a “Shopping Cart” is usually integrated with a company's back office computer systems. Customers can place orders in electronic form directly to the company's ERP system. Limitations of this solution include:

1. Integration is only focused to the selling side of the business.

2. The solution covers only small segment of trading partners (i.e. customers that place very few orders).

3. Customers are forced to change their business process and to retype orders created by their ERP systems into the supplier's shopping cart portal. Most customers that make several orders per week are unwilling to do so.

4. The number of items that can be ordered is limited to items in a catalogue. The solution doesn't support custom ordering.

Another electronic trading solution in the art is a custom-developed solution capable of connecting to ERP/MRP systems, extracting order management documents and submitting the documents to suppliers. Limitations with this solution include:

1. The protocols used, including SMTP or Web Services over HTTP or HTTPS, require involvement of IT resources to reconfigure corporate firewalls and readjust other security policies.

2. For bidirectional document exchange, the trading partners are required to procure and deploy the same software solution or incur additional costs to build/acquire a middleware software solution to translate between the disparate systems.

3. Very often this solution works well only with some ERP/MRP systems and integration with new systems is slow and costly.

4. Support for various business processes and order management documents is, in most cases, very limited.

5. The solutions are incapable of supporting attachments (with drawings, specifications, etc.) to the delivered documents.

Another trading solution known as ABRICA™, available from Obvious Solutions Inc., works as a virtual printer driver that allows a user to send a PDF and XML copy of their business documents (such as a purchase order) to their trading partners. This solution also has limitations, including:

1. Document exchange is non-bidirectional and lacks integration into ERP/MRP systems for updates.

2. The underlying transport mechanism for documents is email-based and therefore, not reliable by definition.

3. Trading partners receiving documents from an Abrica-enabled trading partner are forced to incur additional cost if they want to integrate electronically.

### BRIEF SUMMARY OF THE INVENTION

The trading platform, according to the invention, is a cost-effective, distributed software solution that allows businesses to bi-directionally connect to all of their trading partners, including customers and suppliers, Fortune 500 to SME in size, in a secure and reliable manner. Document exchange with all trading partners is seamless regardless of whether the trading partner is EDI-enabled or has only Internet access via web browsers, enabling conversion of these different types of trading partner technologies to permit electronic document exchange using the same trading platform solution. The trading platform can be tailored to any business and customized to meet the needs of each business' processes.

Cost-effectiveness of the trading platform is achieved by extracting common functionality into centralized and shared community services. All community members share development costs and resources of those community services. Core solution components that have to be deployed at customers' sites are also centralized and shared. A module is used to handle customizations by storing and reading the customizations from a database and applying them as appropriate.

The integration point between the trading platform components installed on company premises and their ERP/MRP systems is referred to as a “plug-in”. The plug-ins expose the same interface to the core components but may implement a number of different technologies for integration with the ERP/MRP systems. Companies with the same ERP/MRP system will in most cases have the same plug-in.

The trading platform uses protocols that enable secure tunnelling through firewalls, for example the JXTA peer-to-peer protocol or SSH. As these protocols don't require any of the incoming ports on corporate firewalls to be opened there is no impact on security policies. Minimal involvement of IT resources reduces the cost and implementation time of the trading platform.

The customizable workflow engine in the trading platform enables mimicking of the different paper-based business processes currently used. Document templates used for document rendering show users all of the documents in a format similar, if not identical, to what they are used to seeing on paper. Minimal and very well localized customizations tremendously reduce the cost and required implementation time of the trading platform.

An automation module delivers to the trading partners all documents created in the ERP/MRP systems and identified as “trading platform ready” without a user's intervention. This simplifies the document exchange process and increases the user's acceptance of the solution.

Attachment functionality allows both trading partners to include additional important documentation with the business documents exchanged. In the case of order management documents, diagrams often accompany purchase orders to show exact specifications required by the customer.

The trading platform enables electronic relationships with all trading partners as long as the partner has an Internet connection and, preferably, an email address. To view, reply or create new documents the partner logs on to a web-based application. If the partner would like to speed up the data entry process and remove potential typing errors they can download and install an ERP Link component. This component has a small footprint and is installed as a printer driver. It extracts data from the print stream and delivers documents, such as order management documents to the selected partners via community services.

Simplicity, business-as-usual, no IT involvement, and no or an extremely small memory footprint are the main characteristics of the web-based application and ERP Link. These characteristics are important in the process of adoption of the electronic relationship with almost all small to mid-sized trading partners.

The trading platform, according to the invention, gives businesses the ability to remove paper from the business process, allowing them to free up resources to pursue valued added activities (such as supplier rationalization programs), increase on time delivery to customers, free up cash by reducing inventory and reduce transcription errors dues due to re-keying of data.

A system for electronic business document exchange between a customer and a supplier, is provided, including a customer computer connected to a network; a supplier computer connected to said network; wherein when said customer computer prints a business document for the supplier, the customer computer extracts order data from the business document and transmits the order data to the supplier computer, and the business document is presented on the supplier computer in a form pre-selected by the supplier. The customer computer or the supplier computer may connect to the network using EDI, a web browser, a printer driver or a desktop computer application and a plug-in.

The purchase order is amendable by the supplier by making a change, and when printing the amended business document, the amended order data is extractable by the supplier computer, and the supplier computer determines the change by comparing the business document to the amended business document, and transmits the amended business document to the customer computer, the amended business document is presentable so that the data prior to the change is presented as crossed out. The supplier computer and said customer computer extract the order data and amended order data via a printer driver.

A method of exchanging a business document between a customer computer and a supplier computer connected to a network, is provided including the steps of (a) printing a business document for the supplier; (b) extracting, through a printer driver, order data from the business document; (c) transmitting the order data to a central mapping software service for translation; (d) transmitting the order data after translation to the supplier computer; and (e) presenting the business document on the supplier computer in a form pre-selected by the supplier.

The transmitting of the order data after translation to the supplier computer may be via EDI; via the Internet; or via a text file.

The method may further include the steps: (f) amending the business document by making a change; (g) printing the amended business document; (h) extracting, by a printer driver, amended order data from the amended business document; (i) determining the change by comparing the order data from the business document to the amended order data from the amended business document; (j) transmitting the amended order data to the central mapping software service for translation; (k) transmitting the amended order data after translation to the supplier computer; and (l) presenting the amended business document such that the data prior to the change appears as crossed out.

A system for electronic document exchange between a first computer operated by a first trading partner and a second computer operated by a second trading partner, is provided, including a first application executable on the first computer, the first application including a GUI; the first application having means to access a data set to determine a preferred document for use by the first and second trading partners; and a printer driver executable on the first computer, the printer driver including means for determining a first document intended for the second trading partner; means for extracting data contained within the document; means for saving the data within a second document; means for delivering the second document to the first or second trading partner; and means for printing the document.

A system for exchanging business documents between a plurality of trading partners is provided, each of the trading partners having a computer, including a plurality of community services accessible by the computers; on, at least one of the computers, a printer driver, for printing the business documents and extracting data from the business documents; on, at least one of the computers, access to an EDI connection and an ERP/MRP system; wherein the community services, when presented with an electronic business document from a first trading partner, format the business document for presentation to a second trading partner in a format selected by the second trading partner.

The community services may include an EDI integrator for integrating EDI communications with the trading partners and a trading partner integrator for integrating communications from a web-based application to other community services. Preferably, attachments are securable to the business document.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows an embodiment of the trading platform according to the invention;

FIG. 2 shows an embodiment of a computer display showing a document exchange audit trail;

FIG. 3 shows an embodiment of a computer display showing marked negotiation changes;

FIG. 4 is a flow chart showing the process by which a purchase order is created;

FIG. 5 is a flow chart showing the process by which the purchase order is processed; and

FIG. 6 shows representations of three different negotiation scenarios using the trading platform according to the invention.

### DETAILED DESCRIPTION OF THE PREFERRED EMBODIMENTS

### Definitions

In this document the following terms have the following meanings:

“trading partner” means a business entity (e.g. corporation, partnership, or sole proprietor), that provides goods or services (referred to as a “supplier”) to other business entities or receives goods or services (referred to as a “customer”) from other business entities;

“users” are individuals that are, or are part of, a trading partner, that use the computers and other tools forming part of the trading platform;

“ERP/MRP system” means a computer application(s) used by a supplier or customer to support the management of their company, and more specifically, to act as the repository for most order management documents used to transact business between trading partners.

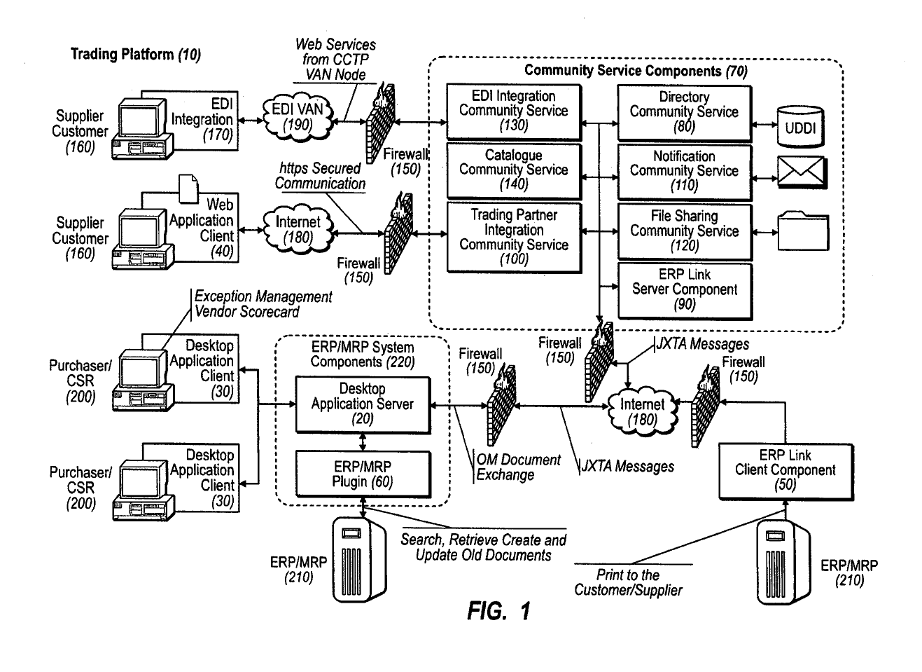

As seen in FIG. 1, a preferred embodiment of the trading platform according to the invention includes four functional components:

a desktop application server 20 in communication with desktop application client 30 and an ERP/MRP plug-in 60,

A web-based application client 40,

ERP Link client component 50, and

community service components 70.

The desktop application client 30, based on the client-server architecture, provides a desktop GUI and is integrated with internal data sources via desktop application server 20.

Web-based application 40 includes a web server application that provides an interface point between trading platform 10 and trading partners without requiring site installations. Trading partners may view documents sent to them, and create and deliver turnaround documents. This enables companies to conduct electronic trading with partners without forcing the company to buy and deploy particular software. Trading partners access web-based application 40 via a web browser.

ERP Link client component 50 provides an interface for trading partners to electronically transfer documents from their ERP/MRP systems to trading platform 10.

The community services 70 are server software applications preferably accessible by all trading platform community members. Community services 70 include several components that provide multi-purpose functionality for business process execution. These components are operated on one or more servers. The trading platform provides the following services:

A directory 80 in communication with a database repository. Directory 80 provides a centralized trading partner repository. Access to the directory community service is restricted to authorized trading platform community members;

Trading partner integrator 100 for integrating communications from web-based application client 40 to other community server components 70 as well as desktop application server 20. Trading partner integrator 100 provides a centralized document repository for trading partners that are not trading platform desktop application users;

Notifier 110 for sending notifications to all trading partners using the trading platform 10 (also known as community members) via email or other message formats, such as SMS. Notifier 110 provides a centralized messaging service to trading partners. Messages sent to notifier 110 contain information required to deliver the message to its intended destination(s);

File sharer 120 for permitting clients to share information in the form of attachments. File sharer 120 allows trading partners to attach additional files to their documents (pictures, drawings, descriptions, etc.);

EDI integrator 130 for integrating EDI communications with users of the trading platform 10. The EDI integrator 130 provides an access point to trading partners that are using EDI networks. The core of the EDI integrator community service 130 is a web service connection to an EDI Value Added Network (VAN) node;

Catalogue 140, in which businesses can store product information for access by trading partners. Catalogue 140 contains the catalogue data required for shopping cart functionality that may be provided via the web-based application; and

ERP Link server 90 for receiving and translating business documents received from ERP Link client 50 into the standard format of the trading platform 10.

As seen in FIG. 1 other components of trading platform 10 include firewalls 150, to protect the business information being communicated.

In the particular embodiment shown in FIG. 1, although this is a representative embodiment and many other configurations are possible, a supplier/customer client 160 uses an EDI integrator 170, and another supplier/customer client uses web-based application client 40. EDI integrator 170 communicates with community server components 70 through EDI VAN 190. An EDI VAN is traditionally is a key component of an EDI connection. It acts as a virtual “middleman” in an EDI transaction, accepting EDI docs from one trading partner and ensuring they are delivered to the intended recipient trading partner. Web-based application client 40 communicates through the Internet 180.

Purchaser/CSR client 200 uses desktop application client 30, which communicates with trading platform ERP/MRP system 210. One trading platform server is running trading platform ERP/MRP system components 220, namely desktop application server 20 and ERP/MRP plug-in 60. The other trading platform ERP/MRP system 210 is running ERP Link client component 50, and communicates with the trading platform community services 70 through the Internet 180.

Computers, clients and servers as used in the trading platform according to the invention, are conventional, and include input and output means, a processor, and memory. Clients and servers may be computers or software operating on computers.

Communications between trading partners preferably use a virtual network in which clients act as peers, such as the JXT A™ Virtual Network, although networks based on other protocols may be used. JXTA is a set of Peer-to-Peer (P2P) protocols initiated by Sun Microsystems™. Peers behind firewalls, NATs or non-IP networks can be reached on the virtual network. JXTA protocol messages allow for seamless connectivity between all peers on a virtual network regardless of the underlying network's physical or logical structure.

The virtual network enables peers to have standardized methods for discovering and advertising other peers, peer groups and network services via TCP with only an outbound port (for example, port 9701) open.

The server side components of trading platform 10 (including all trading platform ERP/MRP systems components 220 and servers operating trading platform community components 70) represent peers organized into a trading platform peer group. A peer must belong to the peer group before it can communicate with other peers (and it can communicate only with peers that have joined the same peer group).

The trading platform peer group includes a designated peer referred to herein as a “rendezvous peer”. The rendezvous peer maintains a list of all trading platform registered peers. Only members of the peer group can query the list and discover other available peers. After completion of a handshaking process (on the rendezvous peer), two peers establish secure pipe connectivity between them. This pipe will be disposed of after completion of the data exchange.

The desktop application is, in a preferred embodiment, a three-tiered client/server application that is installed at trading partner sites. The desktop application includes desktop application client 30 (client tier) and desktop application server 20 (application and data tier). Preferably, there is exactly one server installation and at least one client installation per trading partner.

Desktop application server 20 and trading partner integrator 100 make up a customizable workflow engine. Particular configurations for use by a trading partner are stored in a database within trading partner integrator 100 and propagated to other trading partners as a part of a trading partner agreement data set, which defines the exact business processes as set between two trading partners.

The desktop application includes an automation module. After a trading partner is “enabled for automation” the desktop application will query ERP/MRP system 210 for documents intended for the particular trading partners. The automation module may retrieve documents into the desktop application or retrieve and send documents to the trading partners. The automation module is used to minimize a user's involvement in the document exchange (e.g., eliminating the need to retrieve a document manually and send it to a trading partner).

Business rules can be set such that users will be informed only if some exception occurs (e.g. a change request is received from the trading partner, or a purchase order is unopened for two days, or the like). In other cases the desktop application can be configured to automatically update the ERP/MRP system 210 via ERP/MRP plug-in 60. This feature is referred to as “manage by exception”.

ERP/MRP plug-in 60 provides the integration point between desktop application server 20 and ERP/MRP systems 210. ERP/MRP plug-in 60 is capable of performing transformations between trading platform documents and various ERP data formats by using SQL data access, stored procedures, API, web services, import/export from and to flat files, or other technology as required by the particular ERP/MRP system.

ERP/MRP plug-in 60's flexibility is achieved by providing a web service interface to desktop application server 20. As long as the web service interface is implemented and exposed to desktop application server 20, the web service interface may communicate with different ERP/MRP systems 210.

ERP Link client component 50 is preferably available to the web-based application users. Such users can download and install ERP Link client component 50 on their local computers. Once installed, ERP Link client component preferably appears on the computer's printer driver list (it may be set as the default printer). ERP Link client component 50 preferably has a small footprint and is capable of forwarding all print requests to the regular paper-based print drivers. However, when a print request of order management documents intended for the selected trading partners is made, it is captured and transferred to the community service server 70. Community services 70 then detects from which trading partner the request was sent, uses mapping and extracts all relevant data from the incoming print stream. The extracted data is saved as an order management document in the trading partner integrator 100.

The mapping is the creation of a map, or template, for each document sent via the ERP Link client 50. This template is customized for each trading partner/document type combination and is the set of rules used to determine what data in the incoming document gets “mapped” to what field in the community services database.

The order management document is immediately visible on the web-based application client 30 and optionally is automatically delivered to the trading partner. Configuration of the ERP Link client component 50 by the end user is minimal due to the centralized mapping. This eliminates any time delay between installation of the ERP Link client component 50 and beginning of the electronic document exchange. In the event a map is not available, the incoming document is forwarded to the trading partner via notifier 110.

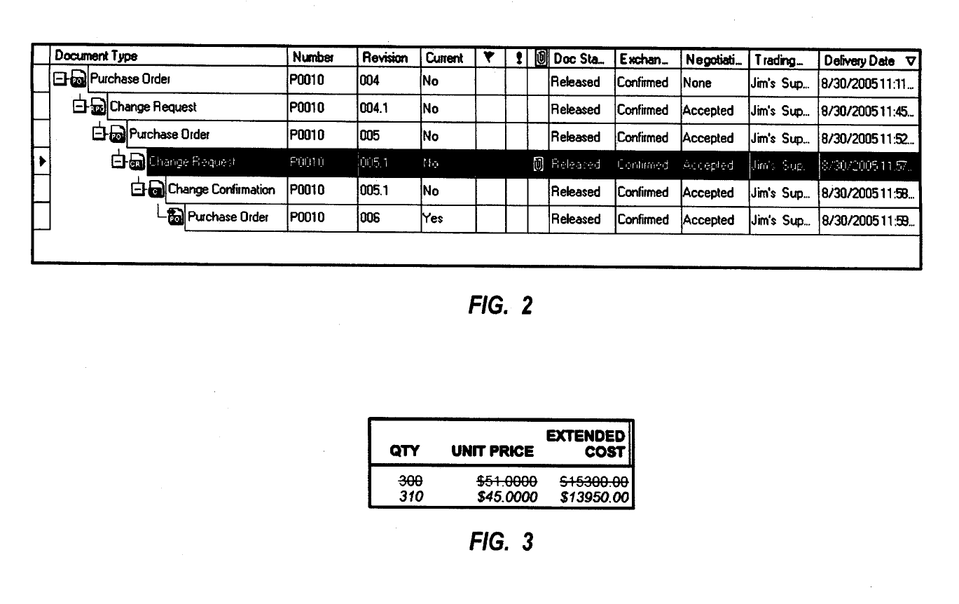

A feature of the desktop application client 30 and web-based application 40 is that they can display the complete audit trail of documents exchanged, showing the negotiation status of the document, and marking changes on the documents in the same manner as users are used to seeing them on the paper. FIGS. 2 and 3 show examples of embodiments of a document exchange audit trail and status, and marked changes on a printed document, respectively.

To provide this trail, the parent and child documents are linked together in the order in which they are created in the business transaction and then displayed accordingly to the end user, e.g. purchase order-order confirmation-change request-new purchase order may be the order of the transaction. The changes are marked in such a way as to mirror the paper-based world by comparing each and every piece of data on two linked documents and determining the differences. Then the first value appears as “crossed out” and the second value is displayed adjacent, above or below the original value to show the relationship. In a preferred embodiment, PDF is the viewing format for end users. This method of displaying documents to users matches the paper-based process in the prior art, where changes are made to a document, and values struck out and amended, hi a preferred embodiment the new value appears in a red color. Moreover trading platform 10 uses the same style to show changes between any two documents from the same document negotiation chain.

A trading partner using the web-based application and ERP Link 50 is capable of starting a transaction by “printing” order management documents to the trading platform 10. When the order management document is printed (at any time), “printing” of the same document is detected and delivery of the change request to the trading partner is triggered if changes are detected between the two versions. If no changes are detected, the second “print” is classified as a duplicate document and is ignored.). As described above the document will be mapped and information extracted during this printing process. Note that it is possible to configure different workflows to be executed when a new revision of the same document is “printed” to trading platform 10.

Order Management Process

The order management process in a typical transaction spans a number of documents from a procurement phase to the final payment. The following describes how the trading platform handles each phase of the order management process.

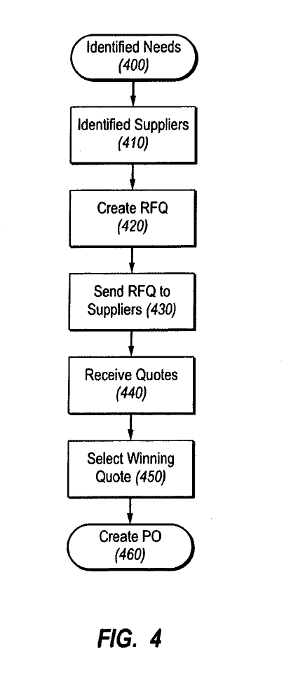

As seen in FIG. 4, the usual first step after an organization identifies a need for procuring some goods or services (step 400) is to identify potential suppliers (step 410). Directory 80 provides a search function whereby trading partners can locate suppliers among trading platform community members based on a number of different search criteria such as company name, city, state, products, services, etc.

The trading partner then creates a document specifying the goods or services to be procured, known as a Request for Quote (RFQ) (step 420). Trading platform 10 can retrieve and distribute RFQ documents to any number of suppliers (Step 430). As well trading platform 10 provides facilities for creation of RFQ documents based on catalogue information from trading partner ERP/MRP systems 210.

Suppliers (also trading partners) then respond to a RFQ with quotes (step 440). A quote document can be created using the trading platform 10 or imported into the trading platform 10. The trading platform 10 can be used to help trading partners compare received quotes, for example by viewing received quotes simultaneously, sorting quotes (by price or other criteria) and selecting the winning quote (step 450).

Data from the selected quote can be used to create a purchase order (PO) document directly in trading platform 10 or in an ERP/MRP system 210 (step 460).

In well-established trading relationship between a customer trading partner and a supplier trading partner, the customer usually doesn't have to send an RFQ to the supplier. The business process in such a relationship begins with the creation of a PO in the customer's ERP/MRP system 210. Trading platform 10 fully supports such business processes. Moreover users are able to exchange documents via trading platform 10 at any point in the business process.

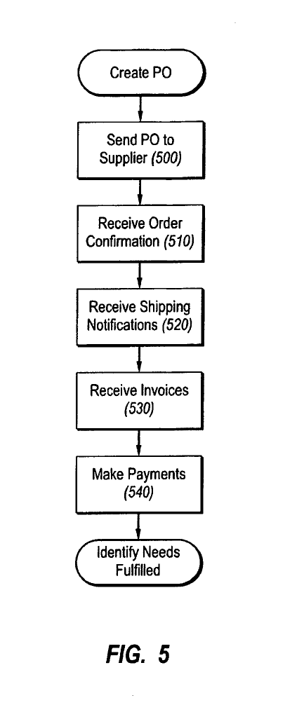

With reference to FIG. 5, a PO created in trading platform 10 or retrieved from the ERP/MRP systems 210 can be sent to the supplier (step 500) with any number of attachments. The supplier accepts the PO if all items on it can be fulfilled in the required quantities, on time and at the stated price. Acceptance of the PO generates an order confirmation, automatically sent back to the customer (step 510). Based on the PO data the supplier can create a sales order document and store it in ERP/MRP system 210 via plug-in 60. Shipment notification documents (step 520) and invoices (step 530) can be retrieved from the supplier's ERP/MRP systems 210 or created in trading platform 10 and sent to the customer.

Upon receiving the goods or services and the invoices for them, the customer can make payments or Electronic Funds Transfer (EFT) to the supplier (step 540).

As in the case of paper-based processes, either the customer or the supplier can initialize negotiation with respect to any document at any point of time during the order management process. “Change Request”, “Cancellation Request”, “Rejection” and “Non-Conformance Report” documents can be used to communicate required changes. In a preferred embodiment, a user, from an existing document, such as a PO, may “right-click” on it to see what options are available. For example, a supplier receives a PO and cannot deliver it all on the day requested, but can do 50% one day and 50% another day. The supplier could create a Change Request based on the PO and send it back to the customer to see if this alternate schedule is acceptable.

A set of statistical analysis and reports can be used to provide a mechanism for trading partner evaluation and comparisons. Users can take advantage of prepared reports or create their own.

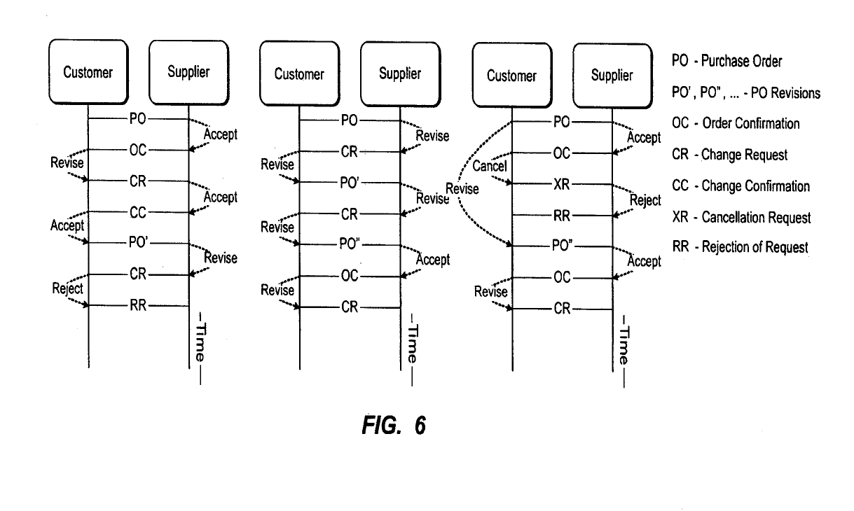

FIG. 6 illustrates some of the possible negotiation scenarios between trading partners. In summary the method and system for exchanging business docs disclosed provides a bidirectional, secure and reliable trading platform allowing trading partners to exchange documents (each trading partner can send or receive documents). Any trading partner is provided four ways in which to access the trading platform: via plug-in 60 (e.g. ERP/MRP system 210 to plug-in 60 to desktop application 30); via EDI (e.g. ERP/MRP system 210 to EDI VAN 190 to community services 70); via the Internet (e.g. a web browser to web based application 40); and/or via printer driver (e.g. ERP Link client component 50 to community services 70). The trading partner with whom documents are being exchanged, may similarly, be using any of the aforementioned means of accessing the trading platform.

Although the particular preferred embodiments of the invention have been disclosed in detail for illustrative purposes, it will be recognized that variations or modifications of the disclosed apparatus lie within the scope of the present invention. For example, the embodiment illustrated relates to the exchange of order management documents, although the platform could be used with other types of documents, for example the exchange of contracts. Furthermore, the system and methods described herein could be recorded on a computer readable medium as a series of instructions for execution by one or more computers. Alternatively, the system and method described herein could be a recorded on a computer program product, for execution by a computer. Also, the methods and system described herein could be embodied as a carrier wave embodying a computer data signal representing sequences of statements and instructions which, when executed by a processor cause the processor to perform the method described herein.

1. A system for electronic business document exchange between a customer and a supplier, the system comprising:
a customer computer connected to a network;
a supplier computer connected to said network;
wherein the customer computer is configured to, in response to a command to print a business document having a first format, extract order data from said business document and transmit said order data, and said supplier computer is configured to present said business document including said order data in a format pre-selected by said supplier based on a defined mapping between the format specified by said business document and said format pre-selected by said supplier.

2. The system of claim 1 wherein the customer computer or the supplier computer connects to said network using EDI.

3. The system of claim 1 wherein the customer computer or the supplier computer connects to said network using a web browser.

4. The system of claim 1 wherein the customer computer or the supplier computer connects to said network using a printer driver.

5. The system of claim 1 wherein the customer computer or the supplier computer connects to said network using a desktop computer application and a plug-in.

6. The system of claim 1 wherein said business document is amendable by said supplier by making a change to create an amended business document comprising amended order data, and when printing said amended business document, said amended order data is extractable by the supplier computer, and said supplier computer determines said change by comparing said business document to said amended business document, and transmits said amended business document to said customer computer, said amended business document is presentable so that said data prior to said change is presented as crossed out.

7. The system of claim 6 wherein said supplier computer and said customer computer extract said order data and amended order data via a printer driver.

8. The system of claim 1 wherein said business document is a purchase order.

9. A method of exchanging a business document between a customer computer and a supplier computer connected to a network, the method comprising:
in response to a command to print a business document for the supplier:
extracting, through a printer driver, order data from said business document having a first format;
transmitting said order data to a central mapping software service for translation;
transmitting said order data after translation to said supplier computer; and
presenting said business document including said order data on said supplier computer in a format pre-selected by said supplier, said format pre-selected by said supplier being different from the first format.

10. The method of claim 9 wherein the transmitting of said order data after translation to said supplier computer is via EDI.

11. The method of claim 9 wherein the transmitting of said order data after translation to said supplier is via the Internet.

12. The method of claim 9 wherein the transmitting of said order data after translation to said supplier is via a text file.

13. The method of claim 9, further comprising:
amending said business document by making a change;
printing said amended business document;
extracting, by a printer driver, amended order data from said amended business document;
determining said change by comparing the order data from said business document to said amended order data from said amended business document;
transmitting said amended order data to said central mapping software service for translation;
transmitting said amended order data after translation to said supplier computer; and
presenting said amended business document such that said data prior to said change appears as crossed out.

14. The method of claim 13 wherein said business document is a purchase order.

15. A system for electronic document exchange between a first computer operated by a first trading partner and a second computer operated by a second trading partner, the system comprising:
a first application executable on said first computer, said first application including a GUI; said first application having means to access a data set to determine a preferred document for use by said first and second trading partners; and
a printer driver executable on said first computer, said print driver executable in response to a print command, said printer driver including:
means for determining a first document intended for transfer to said second trading partner;
means for extracting data contained within said document;
means for saving said data within a second document;
means for delivering said second document including said order data to said first or second trading partner.

16.-19. (canceled)
